(19) United States
(12) Patent Application Publication
(10) Pub. No.: US 2010/0156901 A1
(43) Pub. Date: Jun. 24, 2010

(54) METHOD AND APPARATUS FOR RECONSTRUCTING 3D MODEL

(75) Inventors: Ji Young PARK, Daejeon (KR); Il Kyu Park, Daejeon (KR); Ho Won Kim, Daejeon (KR); Jin Seo Kim, Daejeon (KR); Ji Hyung Lee, Daejeon (KR); Seung Wook Lee, Daejeon (KR); Chang Woo Chu, Daejeon (KR); Seong Jae Lim, Daejeon (KR); Bon Woo Hwang, Daejeon (KR); Bon Ki Koo, Daejeon (KR); Gil Haeng Lee, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/487,458

(22) Filed: Jun. 18, 2009

(30) Foreign Application Priority Data
Dec. 22, 2008 (KR) 10-2008-0131767

(51) Int. Cl. G06T 17/00

(52) U.S. Cl. 345/420

(57) ABSTRACT

A method of reconstructing a 3D model includes reconstructing a 3D voxel-based visual hull model using input images of an object captured by a multi view camera; converting the 3D voxel-based visual hull model into a mesh model; and generating a result of view-dependent rendering of a 3D model by performing the view-dependent texture mapping on the mesh model obtained through the conversion. Further, the reconstructing includes defining a 3D voxel space to be reconstructed; and excluding voxels not belonging to the object from the defined 3D voxel space.

### CROSS-REFERENCE(S) TO RELATED APPLICATIONS

The present invention claims priority of Korean Patent Application No. 10-2008-0131767, filed on Dec. 22, 2008, which is incorporated herein by reference.

### FIELD OF THE INVENTION

The present invention relates to a method of reconstructing and rendering a real-time 3D model; and, more particularly, to a three-dimensional (3D) model reconstruction technology suitable to reconstruct 3D information using the two-dimensional (2D) silhouette information of images, captured from a number of viewpoints and to generate an image from a new viewpoint in real time.

### BACKGROUND OF THE INVENTION

A visual hull reconstruction scheme is well known as a method of reconstructing a 3D model having a voxel (volume+pixel) structure from a silhouette image.

A size of a 3D space to be reconstructed is determined, the entire space is divided into voxels having cubic form, and eight corners constituting each voxel are back-projected onto a silhouette image, thereby obtaining only voxels included within the silhouette as the elements of a model.

In this approach, the accuracy of a model is determined depending on the number of cameras, resolution of an image and size of a voxel. Accordingly, the computational load for improving accuracy is greatly increased.

A triangular mesh model structure is generally used to display a 3D model on a screen. In order to convert a model of a voxel structure into a triangular mesh structure, a marching cube algorithm may be used. Triangles formed from eight voxels adjacent to each other in cubic form are calculated. Since each of the eight voxels may be inside or outside a model, the number of instances of the triangles formed in this case is 2⁸=256. The triangle decided in each case is defined by a marching cube method.

For the more realistic rendering of a model, information of an input image may be used as a texture map of a model. In this case, an input image, which is referred to as a texture of each vertex of a triangle constituting a mesh model, is selected depending on the change of the viewpoint occurring during rendering. This method is called view-dependent texture mapping.

As described above, a method using a 3D volume pixel, that is, a voxel structure, on the basis of a silhouette image is widely used for real-time 3D reconstruction. In this method, a 3D structure is reconstructed in such a manner that object regions inside a silhouette are left and regions outside the silhouette are cut away by back-projecting each of voxels in a 3D voxel space onto a 2D silhouette image. Here, whether the object regions are included is determined by projecting the eight vertexes of a voxel cube onto an image plane. If this calculation is performed on all voxels included in the 3D reconstruction space, the computational load is greatly increased.

To represent a realistic 3D model, it is important to acquire accurate geometric information. A reality can be increased using information of an input image as a texture of a model in the rendering.

Here, in the case where input images are acquired from viewpoints of several directions, there is a need for a view-dependent texturing method that switches an input image which is referred to as a texture, depending on a viewpoint from which a model is displayed on a screen and on the vertex direction of triangular meshes constituting the model. Accordingly, for the real-time reconstruction and rendering of a realistic 3D object, view-dependent texturing and the improvement of the computational speed are required.

### SUMMARY OF THE INVENTION

It is, therefore, a primary object of the present invention to provide a method capable of reducing the computational time of reconstructing a 3D model, in such a way as to extract silhouette information from images captured by a number of cameras, divide a 3D space into voxels and project the center point of each voxel onto an image plane.

Another object of the present invention is to provide a method capable of improving the accuracy of a reconstructed 3D model by converting a voxel model into a mesh structure and performing view-dependent texturing using images captured from a number of viewpoints.

In accordance with one aspect of the invention, there is provided a method of reconstructing a 3D model, including: reconstructing a 3D voxel-based visual hull model using input images of an object captured by a multi view camera; converting the 3D voxel-based visual hull model into a mesh model; and generating a result of view-dependent rendering of a 3D model by performing the view-dependent texture mapping on the mesh model obtained through the conversion.

It is preferable that the reconstructing includes: defining a 3D voxel space to be reconstructed; and excluding voxels not belonging to the object from the defined 3D voxel space.

It is preferable that the converting uses a marching cube algorithm.

It is preferable that the images of the object have silhouette information of multi-viewpoint images and color texture information of the object.

It is preferable that reconstructing back-projects a center point of each voxel defined in the 3D voxel space onto the silhouette information to exclude the voxels not belonging to the object.

It is preferable that the excluding has checking a front and a rear of the 3D model viewed from a rendering viewpoint in order to solve a problem of overlapping of the 3D model.

It is preferable that the converting includes determining an outer mesh with reference to the silhouette information.

In accordance with another aspect of the invention, there is provided an apparatus for reconstructing a 3D model, including a visual hull model reconstruction unit for reconstructing a 3D voxel-based visual hull model using silhouette information of an input multi-viewpoint image and color texture information of an object; a mesh model conversion unit for converting the 3D voxel-based visual hull model, obtained through the reconstruction by the visual hull model reconstruction unit, into a mesh model; and a view-dependent texture mapping unit for performing texture mapping depending on a change in a viewpoint on the mesh model obtained by the mesh model conversion unit.

It is preferable that the visual hull model reconstruction unit includes a 3D voxel space definition unit for defining a 3D voxel space to be reconstructed using the silhouette information of the multi-viewpoint image and the color texture information of the object; and a visual hull model reconstruction unit for determining whether a position of each voxel is placed within the object by back-projecting a center point of said each voxel, defined by the 3D voxel space definition unit, onto an input silhouette image.

It is preferable that the mesh model conversion unit compensates for a loss of outer information resulting from using a coordinate of the center point of voxel with reference to the silhouette information of the multi-viewpoint image when determining an outer mesh.

In accordance with the present invention, the 3D information of a person or an object can be acquired using several cameras, and an image can be generated from a new viewpoint. Accordingly, real-time processing is possible because these processes can use the parallel processing function of a GPU. Furthermore, in accordance with the present invention, whether an object region is included, can be determined on the basis of the center point of a voxel cube, and outer information that may be lost is efficiently compensated for at the mesh conversion step. Accordingly, the computational time can be reduced and the accuracy of a model can be improved.

### BRIEF DESCRIPTION OF THE DRAWINGS

The above and other objects and features of the present invention will become apparent from the following description of embodiments given in conjunction with the accompanying drawings, in which:

FIG. 1 shows a block diagram showing the construction of an apparatus for reconstructing a 3D model in accordance with an embodiment of the present invention;

FIG. 2 describes a flowchart illustrating a method of reconstructing a 3D model in accordance with another embodiment of the present invention;

### DETAILED DESCRIPTION OF THE PREFERRED EMBODIMENTS

In accordance with the present invention, 3D information of an object captured by a number of cameras or a multi view camera is reconstructed in real time, and model structure conversion and view-dependent rendering are performed to achieve realistic 3D model rendering.

The computational load can be greatly reduced through the back-projection of a center point of a voxel other than the eight vertexes of a voxel, and the loss of outer voxels that may occur at this time can be compensated by referring to silhouettes of input images in a mesh conversion process.

In order to render a realistic model, a method of selecting an optimal input image which is referred to as a texture of each vertex of triangular meshes constituting the model and taking the depth of a vertex into consideration upon texturing so as to determine the portions of the model which are partially hidden due to a change in the viewpoint is provided.

Embodiments of the present invention will be described in detail below with reference to the accompanying drawings.

Prior to a description of the embodiments, it is assumed that an object and a background of an input image used in the present invention are separated from each other through a pre-processing process. In the present embodiments, it is also assumed that a number of cameras may be used and the position of each camera is previously known through calibration before an image is captured. The present invention may be applied to any method irrespective of the type of calibration method and object and background separation method used in pre-processing.

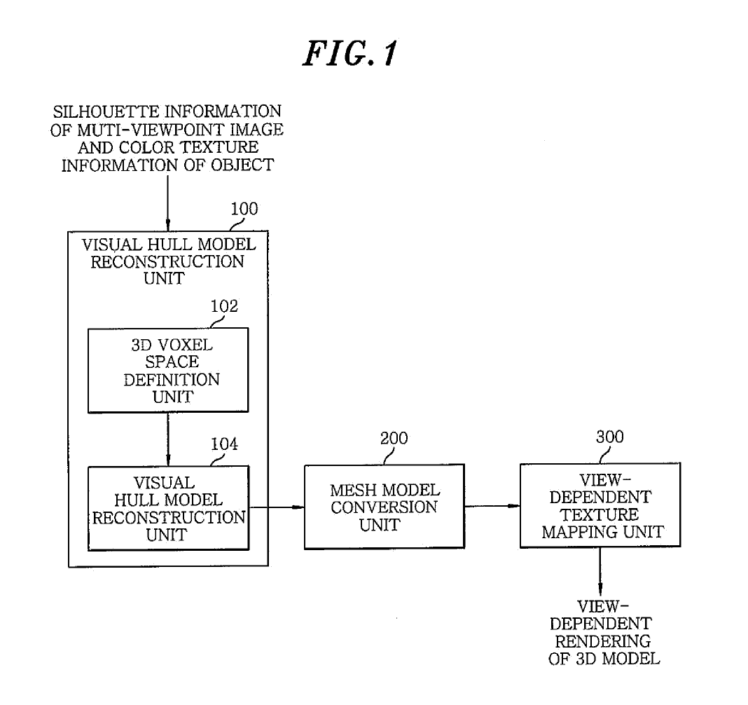

FIG. 1 is a block diagram showing an apparatus for reconstructing a 3D model in accordance with the embodiment of the present invention. The apparatus includes a visual hull model reconstruction unit 100, a mesh model conversion unit 200, and a view-dependent texture mapping unit 300.

As shown in FIG. 1, a visual hull model reconstruction unit 100 includes a 3D voxel space definition unit 102 and a visual hull model reconstruction unit 104. The visual hull model reconstruction unit 100 functions to reconstruct a 3D voxel-based visual hull model from silhouette information of input multi-viewpoint image and color texture information of the object.

A 3D space is divided in a 3D lattice form to be calculated. One unit divided in the lattice form is called a voxel.

The 3D voxel space definition unit 102 of the visual hull model reconstruction unit 100 defines a 3D voxel space to be reconstructed using the silhouette information of the multi-viewpoint image and the color texture information of the object as input.

The visual hull model reconstruction unit 104 determines whether a position of each voxel exists within an object region or within a background region by projecting a center point of each voxel space, defined by the 3D voxel space definition unit 102, onto the input silhouette image.

That is, in the present embodiment, only voxels belonging to the 3D object region are left by excluding voxels belonging to the background from the entire space, so that a model of the object to be reconstructed can be acquired.

Through this process, a visual hull model, which is a maximum shape matching the contour of the object, can be generated in real time.

Meanwhile, the mesh model conversion unit 200 calculates a triangular mesh structure of the 3D voxel model for rendering.

In order to calculate the triangular mesh, a marching cube algorithm is used. Triangles formed from eight voxels adjacent to each other in cubic form are calculated. Since each of the eight voxels may be inside or outside the model, the number of instances of the triangles generated in this case is 2⁸=256. A triangle decided in each case has been defined by the marching cube algorithm.

Here, in order to compensate for the loss of outer information due to the use of the center coordinates for generating a real-time visual hull model, silhouette information is referred when determining outer mesh. That is, in the present embodiment, when the mesh model conversion is performed, the accuracy of the mesh can be improved by making reference to silhouette position information.

Furthermore, in order to generate a triangular mesh in real time, voxel data calculated in the previous process may be uploaded into GPU memory (not shown) of the apparatus for reconstructing a 3D model. The GPU applies a marching cube to input voxel data using a parallel processing scheme and generates the mesh data in the GPU memory. The generated mesh data is stored in the GPU memory. Accordingly, there is an advantage in that, when rendering, the bandwidth between the GPU memory and main memory may not be used because the generated mesh data is directly used from the GPU memory.

Meanwhile, the view-dependent texture mapping unit 300 performs texture mapping which is dependent on a change of the viewpoint, on the mesh model obtained through the conversion by the mesh model conversion unit 200. That is, in order to render a realistic 3D model, input images, for example, the input image information in regard to the vertex constituting the mesh, are used as the texture of the model.

In greater detail, while rendering is performed, the input image which is referred to as the texture of each vertex of the mesh model is changed depending on the change of the viewpoint. That is, inner product is performed on the vector between the center and viewpoint of a camera and the vector between the vertex and viewpoint, and the reference texture is determined as an input image having the smallest value.

Furthermore, the view-dependent texture mapping unit 300 may use a method of, taking the depth of a vertex into consideration upon texturing in order to determine portions of the model which are partially hidden due to the change of the viewpoint. That is, in order to solve the problem of the overlapping of the 3D model, a front and a rear of the model view from the rendering viewpoint are checked.

Accordingly, the view-dependent rendering of the 3D model can be finally performed.

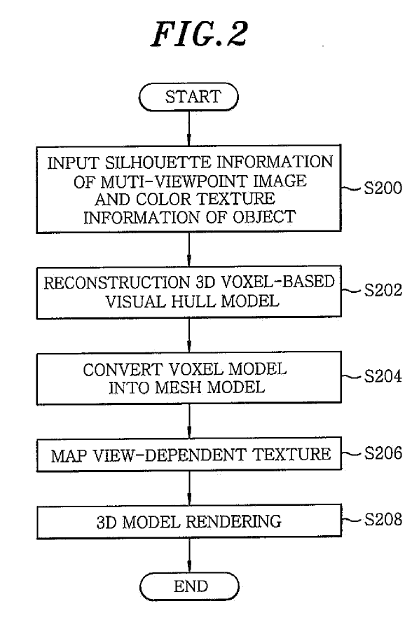

The method of reconstructing a 3D model in accordance with another embodiment of the present invention will now be described with reference to the flowchart of FIG. 2 in connection with the detailed construction.

As shown in FIG. 2, when images of an object, for example, the silhouette information of the multi-viewpoint image and the color texture information of the object, are input to the visual hull model reconstruction unit 100 at step S200, the visual hull model reconstruction unit 100 reconstructs the input object images to a 3D voxel-based visual hull model at step S202. In greater detail, the visual hull model reconstruction unit 100 defines a 3D voxel space to be reconstructed using the silhouette information of the multi-viewpoint input image and the color texture information of the object, and excludes voxels not belonging to the object by back-projecting each voxel onto the silhouette image. That is, the visual hull model reconstruction unit 100 determines whether voxels are included in the object region by back-projecting only the center point of a voxel onto the defined 3D voxel space, and then generates a 3D voxel-based visual hull model.

Thereafter, the mesh model conversion unit 200 converts the voxel model, that is, a 3D voxel-based visual hull model, generated by the visual hull model reconstruction unit 100, into a mesh model at step S204. Here, the mesh model conversion unit 200 improves the accuracy of the mesh by directly referring the position of a silhouette in order to compensate for the loss of a voxel resulting from the projecting the center point of the voxel.

Meanwhile, the view-dependent texture mapping unit 300 maps a view-dependent texture to the mesh model obtained by the mesh model conversion unit 200 at step S206. That is, in order to render a realistic 3D model, the view-dependent texture mapping unit 300 selects an input image as a texture for each of the vertexes constituting the mesh model.

Here, in the present embodiment, in order to determine portions of the model which are partially hidden in accordance with the change in the viewpoint, the depth of the vertex is taken into consideration upon texturing.

The final result of the rendering of the 3D model can be obtained using this view-dependent texture mapping at step S208. As described above, in the present embodiment, after silhouette information is extracted from images acquired through a number of cameras, 3D space is divided into voxels and the center point of each voxel is projected onto an image plane, thereby reconstructing a 3D model. Furthermore, the voxel model is converted into a mesh structure, and view-dependent texturing is performed using images captured from a plurality of viewpoints.

While the invention has been shown and described with respect to the embodiments, it will be understood by those skilled in the art that various changes and modification may be made without departing from the scope of the invention as defined in the following claims.

What is claimed is:

1. A method of reconstructing a 3D model, comprising:
reconstructing a 3D voxel-based visual hull model using input images of an object captured by a multi view camera;
converting the 3D voxel-based visual hull model into a mesh model; and
generating a result of view-dependent rendering of a 3D model by performing the view-dependent texture mapping on the mesh model obtained through the conversion.

2. The method of claim 1, wherein the reconstructing includes:
defining a 3D voxel space to be reconstructed; and
excluding voxels not belonging to the object from the defined 3D voxel space.

3. The method of claim 1, wherein the converting uses a marching cube algorithm.

4. The method of claim 1, wherein the images of the object have silhouette information of multi-viewpoint images and color texture information of the object.

5. The method of claim 4, wherein the reconstructing back-projects a center point of each voxel defined in the 3D voxel space onto the silhouette information to exclude the voxels not belonging to the object.

6. The method of claim 5, wherein the excluding has checking a front and a rear of the 3D model viewed from a rendering viewpoint in order to solve a problem of overlapping of the 3D model.

7. The method of claim 4, wherein the converting includes determining an outer mesh with reference to the silhouette information.

8. An apparatus for reconstructing a 3D model, comprising:
a visual hull model reconstruction unit for reconstructing a 3D voxel-based visual hull model using silhouette information of an input multi-viewpoint image and color texture information of an object;
a mesh model conversion unit for converting the 3D voxel-based visual hull model, obtained through the reconstruction by the visual hull model reconstruction unit, into a mesh model; and
a view-dependent texture mapping unit for performing texture mapping depending on a change in a viewpoint on the mesh model obtained by the mesh model conversion unit.

9. The apparatus of claim 8, wherein the visual hull model reconstruction unit includes:
a 3D voxel space definition unit for defining a 3D voxel space to be reconstructed using the silhouette information of the multi-viewpoint image and the color texture information of the object; and
a visual hull model reconstruction unit for determining whether a position of each voxel is placed within the object by back-projecting a center point of the each voxel, defined by the 3D voxel space definition unit, onto an input silhouette image.

10. The apparatus of claim 9, wherein the mesh model conversion unit compensates for a loss of outer information resulting from using a coordinate of the center point of the voxel with reference to the silhouette information of the multi-viewpoint image when determining an outer mesh.
